(19) United States
(12) Patent Application Publication
(10) Pub. No.: US 2022/0005023 A1
(43) Pub. Date: Jan. 6, 2022

(54) Programmable Transactions

(71) Applicant: Visa International Service Association, San Francisco, CA (US)

(72) Inventors: Terry Angelos, Los Altos, CA (US); Cuy Sheffield, Menlo Park, CA (US); Anirudh Malkani, Menlo Park, CA (US); Anthony Shanley, San Jose, CA (US)

(21) Appl. No.: 17/057,490

(22) PCT Filed: May 17, 2019
(86) PCT No.: PCT/US2019/032924

§ 371 Date: Nov. 20, 2020

Related U.S. Application Data
(60) Provisional application No. 62/675,374, filed on May 23, 2018.

(51) Int. Cl. G06Q 20/36; G06Q 20/38; G06Q 20/40

(52) U.S. Cl. CPC G06Q 20/3678; G06Q 20/4014; G06Q 20/38215

(57) ABSTRACT

One embodiment of the invention is directed to a method that utilizes a mapping between a blockchain address and a payment credential. In some embodiments, the mapping may have been previously generated based on blockchain data (e.g., one or more blockchain tokens) associated with a blockchain address and a previously provided set of conditions. An authorization request message is later received that includes the payment credential. The blockchain address may be retrieved from the mapping and it may be determined whether the set of conditions have been met. One or more operations may be executed based on determining the set of conditions have been met.

### CROSS REFERENCE TO RELATED APPLICATIONS

This international application claims priority to U.S. Provisional Patent Application No. 62/675,374, filed on May 23, 2018, the disclosure of which is herein incorporated by reference in its entirety for all purposes.

### BACKGROUND

One of the main innovations of permissionless cryptocurrencies is the ability to make money programmable. This means the ability to create rules that define when and how value can be exchanged between a payer and payee. Ethereum allows this permissionless creation of secure, immutable rules that govern a transaction through the implementation of a “smart contract.” There is a thriving developer ecosystem where entrepreneurs are using smart contracts to build decentralized applications (dapps) that securely automate away functions from traditional centralized apps. Currently, these dapps leverage either the native cryptocurrency (Bitcoin or Ether) or their own application specific tokens (usually Ethereum based) to allow for payments between parties.

While Bitcoin and other cryptocurrencies are unlikely to compete for in-store merchant payments, they have the potential to gain strong traction as a default payment method within decentralized applications within smart contracts. However, these transactions suffer from the existing volatility present in permissionless cryptocurrencies that currently make them ill-suited for regular medium of exchange. Potential solutions under development such as stable coins (decentralized or digital fiat) are targeting this opportunity to become the defacto medium of exchange for permissionless cryptocurrencies. This ability to combine transaction programmability with a stable means of exchange allows for new and innovative applications and business models in our increasingly programmed world.

### SUMMARY

Embodiments of the invention include the use of blockchain systems such as Ethereum as mechanisms to implement offers that are linked to the use of payment devices such as credit or debit cards and/or mobile communication devices. The user's offer eligibility may be determined based on one or more blockchain tokens that indicate ownership, financial instruments possessed by the user, membership, or the like. Once associated with the offer, the user may subsequently use his payment device to initiate a transaction with a merchant. The transaction may proceed using conventional techniques until an authorization response message provided by the issuer is obtained by a processing network computer and/or a condition management computer. Either device may be configured to retrieve transaction data from the authorization response message and/or blockchain data from a corresponding the blockchain address to determine whether a set of conditions associated with the offer have been met. If the conditions have been met, one or more additional operations may be performed. For example, the user may receive a statement credit for some portion of the purchase price of the transaction and/or a blockchain token that provides access to an online resource may be issued to the user's blockchain address based on the transaction. The particular operations performed when the set of conditions are met are numerous and vary depending on the offer.

One embodiment of the invention is directed to a method comprising: obtaining, by a server computer, a mapping between a blockchain address and a payment credential associated with a user. In some embodiments, the mapping may have been generated based at least in part on blockchain data associated with the blockchain address and a set of conditions. The method may further comprise receiving, by the server computer, an authorization request message comprising message data that includes at least the payment credential. The method may further comprise obtaining, by the server computer, the set of conditions based at least in part on the payment credential. The method may further comprise determining that the set of conditions have been met based on at least a portion of the message data. The method may further comprise executing one or more operations based on determining that the set of conditions have been met.

Another embodiment of the invention is directed to a server computer (e.g., a processing network computer, a condition management computer, etc.) configured to perform the above method.

These and other embodiments of the invention are described in further detail below.

### BRIEF DESCRIPTION OF THE DRAWINGS

FIG. 1 shows a block diagram of an exemplary transaction processing system 100.

FIG. 2 shows a block diagram of an exemplary condition management computer, according to some embodiments.

FIG. 3 depicts an example of a portion of a blockchain 300 according to some embodiments.

FIG. 4 depicts a flow diagram illustrating a first and second enrollment process, in accordance with at least one embodiment.

FIG. 5 depicts a flow diagram illustrating an example method for transaction processing during which the user receives a credit based at least in part on meeting a set of conditions, according to some embodiments.

FIG. 6 depicts a flow diagram illustrating an example method for transaction processing during which the user receives a blockchain token based at least in part on meeting a set of conditions, according to some embodiments.

FIG. 7 depicts a flow diagram illustrating an example method for transaction processing during which the user receives a benefit based at least in part on third-party data collected via a smart contract of a blockchain.

### DETAILED DESCRIPTION

Prior to discussing embodiments of the invention, some descriptions of some terms may be useful.

A “user device” may comprise any suitable electronic device that may be operated by a user, which may also provide remote communication capabilities to a network. A “mobile communication device” may be an example of a “user device” that can be easily transported. Examples of remote communication capabilities include using a mobile phone (wireless) network, wireless data network (e.g. 3G, 4G or similar networks), Wi-Fi, Wi-Max, or any other communication medium that may provide access to a network such as the Internet or a private network. Examples of mobile communication devices include mobile phones (e.g. cellular phones), PDAs, tablet computers, net books, laptop computers, personal music players, hand-held specialized readers, etc. Further examples of mobile communication devices include wearable devices, such as smart watches, fitness bands, ankle bracelets, rings, earrings, etc., as well as automobiles with remote communication capabilities. In some embodiments, a mobile communication device can function as a payment device (e.g., a mobile communication device can store and be able to transmit payment credentials for a transaction).

A “payment device” may include any suitable device that may be used to conduct a financial transaction, such as to provide payment credentials to a merchant. The payment device may be a software object, a hardware object, or a physical object. As examples of physical objects, the payment device may comprise a substrate such as a paper or plastic card, and information that is printed, embossed, encoded, or otherwise included at or near a surface of an object. A hardware object can relate to circuitry (e.g., permanent voltage values), and a software object can relate to non-permanent data stored on a device. A payment device may be associated with a value such as a monetary value, a discount, or store credit, and a payment device may be associated with an entity such as a bank, a merchant, a payment processing network, or a person. Suitable payment devices can be hand-held and compact so that they can fit into a user's wallet and/or pocket (e.g., pocket-sized). Example payment devices may include smart cards, magnetic stripe cards, keychain devices (such as the Speedpass™ commercially available from Exxon-Mobil Corp.), etc. Other examples of payment devices include payment cards, smart media, transponders, and the like. If the payment device is in the form of a debit, credit, or smartcard, the payment device may also optionally have features such as magnetic stripes. Such devices can operate in either a contact or contactless mode.

A “credential” may be any suitable information that serves as reliable evidence of worth, ownership, identity, or authority. A credential may be a string of numbers, letters, or any other suitable characters, as well as any object or document that can serve as confirmation. Examples of credentials include value credentials, identification cards, certified documents, access cards, passcodes and other login information, etc.

“Payment credentials” may include any suitable information associated with an account (e.g. a payment account and/or payment device associated with the account). Such information may be directly related to the account or may be derived from information related to the account. Examples of account information may include a PAN (primary account number or “account number”), user name, expiration date, and verification values such as CVV, dCW, CW2, dCVV2, and CVC3 values.

A “digital wallet” or “digital wallet application” can include an electronic device or software program (e.g., an application operating on a user device) that allows an individual to conduct electronic commerce transactions. A digital wallet may store user profile information (e.g., the user's name, phone number, address, etc.), payment credentials, bank account information, one or more digital wallet identifiers and/or the like and can be used in a variety of transactions, such as but not limited to eCommerce, social networks, money transfer/personal payments, mobile commerce, proximity payments, gaming, and/or the like for retail purchases, digital goods purchases, utility payments, purchasing games or gaming credits from gaming websites, transferring funds between users, and/or the like. A digital wallet may be designed to streamline the purchase and payment process. A digital wallet may allow the user to load one or more payment cards onto the digital wallet so as to make a payment without having to enter an account number or present a physical card.

In some embodiments, a digital wallet can store one or more blockchain addresses corresponding to blockchain accounts that are associated with the user and maintained in a publically accessible ledger (e.g., a blockchain).

A “blockchain” may be a distributed database that may be used to maintain a publically accessible ledger. The ledger may include a continuously growing list of records, called blocks. In some embodiments, the blocks are linked using cryptography such that each block contains a cryptographic hash of the previous block, a timestamp, and transaction data. A blockchain is typically managed by a peer-to-peer network collectively adhering to a protocol for validating new blocks. Once recorded, the data in any given block cannot be altered retroactively without the alteration of all subsequent blocks and the collusion of the network. This allows the blockchain to serve as a data record between parties that is both verifiable and permanent. A blockchain may be spread out over a plurality of nodes (e.g., of a distributed computing system).

A “smart contract” may be a computer protocol intended to facilitate, verify, or enforce the performance of a set of rules. It may include a technology feature of a blockchain. In some embodiments, a smart contract of a blockchain may be visible to each participant of the blockchain. Smart contracts can be used to collect and/or provide third party data (any suitable data obtained from any suitable third party source).

A “blockchain token” may refer to a digital asset that is maintained within a blockchain. By way of example, a blockchain token may represent a user's ownership of an asset (e.g., a title of property such as a home, a car, etc.), a financial instrument associated with the user (e.g., one or more stocks, bonds, etc.), a membership of the user (e.g., a loyalty program membership, membership in an organization, etc.), and/or the user's eligibility with respect to one or more offers. A blockchain token may conform to a predetermined and public specification. For example, a blockchain token may include an ERC-20 token, an ERC-721 token, or any suitable token associated with an Ethereum blockchain. It should be appreciated that Ethereum is used merely for illustrative purposes. It is contemplated that a blockchain token may take any suitable form based at least in part on the particular blockchain being utilized.

A “user” may include an individual. In some embodiments, a user may be associated with one or more personal accounts and/or mobile devices. The user may also be referred to as a cardholder, account holder, or consumer in some embodiments.

A “resource provider” may be an entity that can provide a resource such as goods, services, information, and/or access. Examples of resource providers includes merchants, data providers, transit agencies, governmental entities, venue and dwelling operators, etc. A “merchant” may typically be an entity that engages in transactions and can sell goods or services, or provide access to goods or services. A resource provider may operate a resource provider computer.

An “acquirer” may typically be a business entity (e.g., a commercial bank) that has a business relationship with a particular merchant or other entity. Some entities can perform both issuer and acquirer functions. Some embodiments may encompass such single entity issuer-acquirers. An acquirer may operate an acquirer computer, which can also be generically referred to as a “transport computer”.

An “authorizing entity” may be an entity that authorizes a request. Examples of an authorizing entity may be an issuer, a governmental agency, a document repository, an access administrator, etc. An “issuer” may typically refer to a business entity (e.g., a bank) that maintains an account for a user. An issuer may also issue payment credentials stored on a user device, such as a cellular telephone, smart card, tablet, or laptop to the consumer. An authorizing entity may operate an authorizing entity computer.

An “access device” may be any suitable device that provides access to a remote system. An access device may also be used for communicating with a resource provider computer or any other suitable system. An access device may generally be located in any suitable location, such as at the location of a merchant. An access device may be in any suitable form. Some examples of access devices include POS or point of sale devices (e.g., POS terminals), cellular phones, PDAs, personal computers (PCs), tablet PCs, hand-held specialized readers, set-top boxes, electronic cash registers (ECRs), automated teller machines (ATMs), virtual cash registers (VCRs), kiosks, security systems, access systems, and the like. An access device may use any suitable contact or contactless mode of operation to send or receive data from, or associated with, a mobile communication or payment device. In some embodiments, where an access device may comprise a POS terminal, any suitable POS terminal may be used and may include a reader, a processor, and a computer-readable medium. A reader may include any suitable contact or contactless mode of operation. For example, exemplary card readers can include radio frequency (RF) antennas, optical scanners, bar code readers, or magnetic stripe readers to interact with a payment device and/or mobile device. In some embodiments, a cellular phone, tablet, or other dedicated wireless device used as a POS terminal may be referred to as a mobile point of sale or an “mPOS” terminal.

A “processing network computer” may include a server computer used for processing network data. In some embodiments, the processing network computer may be coupled to a database and may include any hardware, software, other logic, or combination of the preceding for servicing the requests from one or more client computers. The processing network computer may comprise one or more computational apparatuses and may use any of a variety of computing structures, arrangements, and compilations for servicing the requests from one or more client computers. In some embodiments, the processing network computer may operate multiple server computers. In such embodiments, each server computer may be configured to process transaction for a given region or handles transactions of a specific type based on transaction data.

The processing network computer may include data processing subsystems, networks, and operations used to support and deliver authorization services, exception file services, and clearing and settlement services. An exemplary processing network computer may include VisaNet™. Networks that include VisaNet™ are able to process credit card transactions, debit card transactions, and other types of commercial transactions. VisaNet™, in particular, includes an integrated payments system (Integrated Payments system) which processes authorization requests and a Base II system, which performs clearing and settlement services. The processing network computer may use any suitable wired or wireless network, including the Internet.

An “authorization request message” may be an electronic message that requests authorization for a transaction. In some embodiments, it is sent to a transaction processing computer and/or an issuer of a payment card to request authorization for a transaction. An authorization request message according to some embodiments may comply with ISO 8583, which is a standard for systems that exchange electronic transaction information associated with a payment made by a user using a payment device or payment account. The authorization request message may include an issuer account identifier (e.g., a payment credential) that may be associated with a payment device or payment account. An authorization request message may also comprise additional data elements corresponding to “identification information” including, by way of example only: a service code, a CW (card verification value), a dCW (dynamic card verification value), a PAN (primary account number or “account number”), a payment token, a user name, an expiration date, etc. An authorization request message may also comprise “transaction data,” such as any information associated with a current transaction, such as the transaction amount, merchant identifier, merchant location, acquirer bank identification number (BIN), card acceptor ID, information identifying items being purchased, etc., as well as any other information that may be utilized in determining whether to identify and/or authorize a transaction.

An “authorization response message” may be a message that responds to an authorization request. In some cases, it may be an electronic message reply to an authorization request message generated by an issuing financial institution or a transaction processing computer. The authorization response message may include, by way of example only, one or more of the following status indicators: Approval—transaction was approved; Decline—transaction was not approved; or Call Center—response pending more information, merchant must call the toll-free authorization phone number. The authorization response message may also include an authorization code, which may be a code that a credit card issuing bank returns in response to an authorization request message in an electronic message (either directly or through the transaction processing computer) to the merchant's access device (e.g. POS equipment) that indicates approval of the transaction. The code may serve as proof of authorization.

A “server computer” may include a powerful computer or cluster of computers. For example, the server computer can be a large mainframe, a minicomputer cluster, or a group of servers functioning as a unit. In one example, the server computer may be a database server coupled to a Web server. The server computer may comprise one or more computational apparatuses and may use any of a variety of computing structures, arrangements, and compilations for servicing the requests from one or more client computers.

Embodiments of the invention may include systems and methods for enabling data maintained in a blockchain to be utilized to influence operations performed by a processing network computer in response to receiving a request to perform a transaction (e.g., an authorization request message). An exemplary processing network computer may include VisaNet™ that may be configured to process credit card transactions, debit card transactions, and other types of commercial transactions. Example blockchains may include Ethereum, Ripple, Stellar, EOS, Neo, Dfinity, or Tezos.

In some embodiments, a transaction may involve a recurring billing (e.g., a home utility-related monthly transaction), a static offer (e.g., enroll a debit card and earn 10% back when you spend at least $50 at merchant X), a spend based offer that may further depend on transaction history variables such as aggregate purchase amounts, how recent a purchase was made, purchase frequency (e.g., new customer, frequent customer, etc.), to name a few.

Some embodiments may include verifying eligibility of a user to enroll in an offer and/or program and/or to receive a benefit (e.g., a discount, a statement credit, another blockchain token, etc.) based at least in part on provable attestations in the form of blockchain tokens already associated with the user's blockchain address. By way of example, future property titles can issued as blockchain tokens (e.g., an ERC-20 token, an ERC-721 token, or the like) on a blockchain (e.g., an Ethereum blockchain). As a non-limiting example, activation of an offer such as “Get 20% back at Home Improvement Merchant X if you bought a home in the last 6 months” may depend on verifying the user's blockchain address holds a blockchain token that indicates ownership/ownership interest of real property, and, in this example, that the blockchain token was issued (e.g., perhaps by the lender) within the last 6 months from the current date.

Some embodiments may include utilize a decentralized oracle maintained by the blockchain to determine whether an operation is to be performed (e.g., an offer is to be honored, a blockchain token is to be issued, etc.). A “decentralized oracle” may include a smart contract that is configured to retrieve data from one or more third-party sources (e.g., news outlets, weather reports, stock market reports, or any suitable third-party computer). This third-party data may then be utilized to determine whether the operation is to be performed. By way of example, one potential offer might indicate that the user will receive 20% off their purchases in the form of a statement credit when a sports team wins a home game. The offer may be limited to a time period. For example, the offer may only be honored with 24 hours subsequent to the sports team winning a home game (as determinable by the third party data collected by a decentralized oracle). Another example might be “Get 10% back at merchant X any day it rains in State Y.” The weather in state Y may be ascertainable from a number of public sources. However, it may be insecure and risky to rely on a single public API influencing a significant value transfer (5% off for thousands of customers) because that API could be tampered with. A better solution can be to use a smart contract to create a decentralized oracle maintain by the blockchain, where multiple APIs (e.g., multiple weather websites) feed into a smart contract that takes an action (e.g., activates an offer, causes a merchant to issue a blockchain token associated with the offer to one or more users, etc.) based on the consensus among those APIs.

Other use cases may include the utilization of blockchain token that rights of use to a digital asset in gaming contexts. By way of example, an ERC-721 token (or other blockchain token) could be associated to a user's blockchain address to indicate that the user has rights to access a particular gaming feature (e.g., character, level, clothing, weapons, objects, currency, a digital collectible, etc., of a particular gaming platform). In some embodiments, a third party token provider (e.g., Rarebits) could accept a payment using the user's payment device (e.g., a debit/credit card, a mobile communications device that stores payment credentials, etc. A smart contract of the blockchain may be configured to cause an ERC-721 token to be automatically sent and associated with the blockchain address associated with the user.

As another example, a blockchain token representing access rights to a gaming feature may be issued in response to the user conducting a transaction with a resource provider. By way of example, a merchant could provide a free and transferable access to a particular gaming feature by issuing a blockchain token to a blockchain address associated with the user. In some embodiments, these techniques could also be used to verify authenticity of an item purchased. For example, a blockchain token that indicates a certificate of authenticity may be issued to a user's blockchain address when the user purchases an item (e.g., a diamond engagement ring, an expensive handbag, a collectible item, and the like).

In some embodiments, a financial instrument (e.g., regulatory compliant stocks, bonds, etc.) may be represented as a blockchain token and associated with a user's blockchain address (e.g., by an online brokerage system, from a company website, or any suitable securities token issuer). Utilizing such blockchain tokens can increase liquidity, reduce cost of issuance, and provide new models of shareholder engagement. Securities token issuers can increase loyalty and sales of their products from investors by providing a blockchain token that indicates ownership in the financial instrument and which can have additional utility (e.g., such as being utilized to provide a benefit to the holder of the token in response to performing a transaction with a payment device). For example, restaurant X could automatically give their securities token holders (shareholders) 10% off anytime they make a purchase at restaurant X.

As yet another example, resource providers could issue a blockchain token to a user's blockchain address upon enrollment in a loyalty program or sell membership that provides discounts at select resource providers. These blockchain tokens can be utilized (e.g., at the time of transaction or any suitable time) to verify user eligibility in receiving the associated benefit. In some embodiments, a transaction can trigger one or more of additional blockchain tokens to be issued to the blockchain address of the user (e.g., blockchain tokens that provide additional/greater discounts). One example might be that a particular organization may issue membership as an ERC-20 token. Token holders may link a payment credential to their blockchain address in order to get 5% off any fuel purchase as long as that particular blockchain token is associated with their blockchain address.

In a further example, a sandwich shop may allow customers to sign up for loyalty program by providing the user's blockchain address. The sandwich shop may issue a blockchain token to the user's blockchain address that indicates the user's membership in the loyalty program. The user may associate a payment credential (or device) to the blockchain address in order to receive loyalty program benefits in response to performing one or more transactions performed with the merchant utilizing the payment credential. In some embodiments, when the user performs subsequent transactions with the merchant utilizing the payment credential, an additional token may be generated and associated with their blockchain address that activates an additional benefit (e.g., a larger discount) on their next transaction with the merchant that utilizes the payment credential.

In some embodiments, rather than using the techniques described above to create programmable transactions by activating offers/benefits within a processing network, they could also be used to trigger programmable payments. This could have significant implications for insurance, government, and non-profit aid disbursements that require verifiable digital identity.

As a non-limiting example, a blockchain token may be associated with the user's blockchain address. The blockchain token may include a smart contract that could trigger a payment to a user's financial account. By way of example, a blockchain token indicating membership in a public assistance program may be associated with the user's blockchain account. The blockchain token may be utilized by computers associated with the program in order to verify the user's eligibility to qualify for disbursements and/or an amount and periodicity with which disbursements are to be made. The user may link a payment credential to the blockchain address and, if the user qualifies for disbursements, payments are automatically made to their financial account.

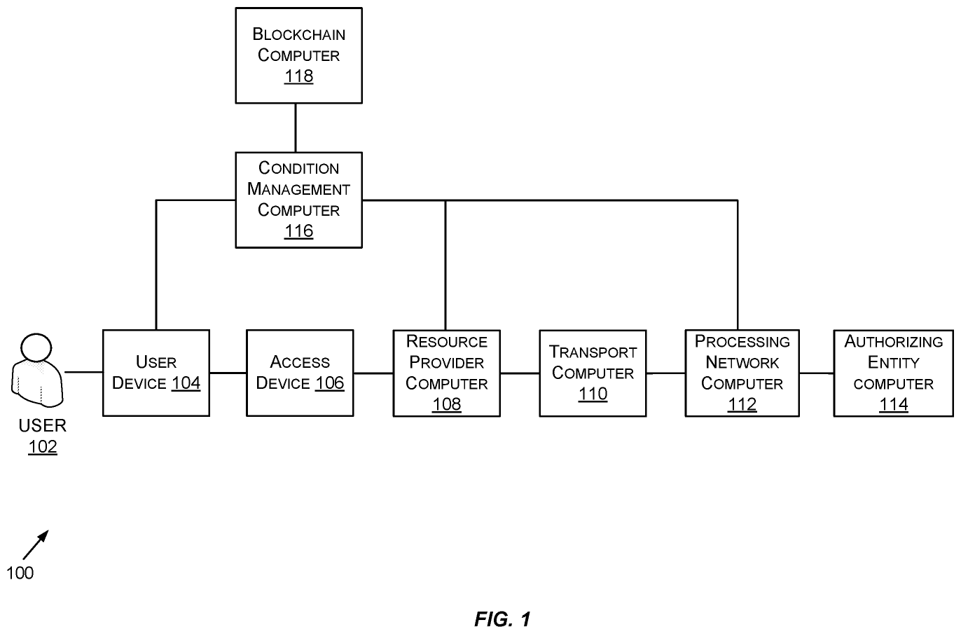

FIG. 1 shows a block diagram of an exemplary transaction processing system 100. FIG. 1 shows a user 102 that can operate a user device 104, an access device 106, a resource provider computer 108, a transport computer 110, a processing network computer 112, an authorizing entity computer 114, a condition management computer 116, and a blockchain computer 118 (hereinafter, collectively referred to as “the computing devices”).

The transaction processing system 100 includes a particular number of computing devices although any suitable number of computing devices may be utilized. Each of the computing devices may be in operative communication with each other via any suitable communication medium using any suitable communications protocol. Suitable communications media for communications between the components shown in FIG. 1 may include any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, Bluetooth, Bluetooth Low Energy (BLE), and/or the like); and/or the like.

Messages between the computing devices of FIG. 1 may be transmitted using a communications protocols such as, but not limited to, File Transfer Protocol (FTP); HyperText Transfer Protocol (HTTP); Secure Hypertext Transfer Protocol (HTTPS), Secure Socket Layer (SSL), ISO (e.g., ISO 8583) and/or the like.

Each of the computing devices may be capable of accessing the Internet, such as a personal computer, cellular or wireless phones, personal digital assistants (PDAs), tablet computers, laptop computers, handheld specialized readers, routers, modems, server computers, or the like.

In some embodiments, the condition management computer 116 may be configured to provide one or more interfaces with which a resource provider and/or user 102 may perform corresponding enrollment processes. The user 102 may access the one or more interfaces via a link, URL, or the like provided to the user. In some embodiments, the condition management computer 116 may advertise one or more offers corresponding to sets of conditions provided by one or more resource providers. In some embodiments, the advertisement may be provided via a digital wallet operating on the user device 104, via an electronic message provided to the user's email address, or by any suitable electronic means.

The condition management computer 116 may store any suitable data collected from these processes such as a set of conditions (e.g., a set of conditions corresponding to offer details provided by the resource provider), one or more operations to be performed if the set of conditions are met, a mapping between a user's payment credential, the user's blockchain address, and user contact information (e.g., the user's phone number, email address, etc.) as provided by the user (or an application such as a digital wallet that operates on the user device 104). The condition management computer 116 may operate as a blockchain node of a blockchain network (not depicted) such as, but not limited to, an Ethereum blockchain network or the condition management computer 116 may communicate with the blockchain computer 118 which may be configured to operate as a blockchain node of the blockchain network. It should be appreciated that although the condition management computer 116 is depicted as being different from the processing network computer 112, in some embodiments, the processing network computer 112 may perform the functionality discussed in reference to the condition management computer.

The condition management computer 116 may be configured to receive, from the resource provider computer 108 during a first enrollment process, a set of conditions and an indication of one or more operations to be performed when the set of conditions are met. The condition management computer 116 may be configured to receive, from the user device 104 during a second enrollment process (e.g., a second enrollment process conducted after the first enrollment process) a payment credential associated with the user, a blockchain address associated with the user, and, in some cases, contact information associated with the user such as an email address and/or a phone number during a second enrollment process.

The condition management computer 116 may be configured to request blockchain data (e.g., such as blockchain tokens associated with the blockchain address provided during the second enrollment process) from the blockchain computer 118 or the condition management computer 116 may obtain the blockchain data associated with said blockchain address directly from the blockchain network. In some embodiments, the condition management computer 116 may be configured to verify that at least one of the set of conditions is met based at least in part on the blockchain data. By way of example, the resource provider may have specified that one condition that is to be met before the one or more operations are to be performed (e.g., a discount, statement credit, issuance of a subsequent blockchain token) is that a particular type of blockchain token has been previously associated with the blockchain address of the user. This is merely an example, any suitable blockchain data (e.g., one or more blockchain tokens, data provided by a decentralized oracle/smart contract of the blockchain, etc.) may be utilized to determine, at least in part, whether a condition has been met. In some embodiments, the condition management computer 116 may be configured to store the set of conditions as an association to the payment credential and/or send an association between the set of conditions and the payment credential to the processing network computer 112, etc.

The condition management computer 116 may be configured to store any suitable combination of the data received from the user device 104 and/or the resource provider computer 108 in memory (e.g., local memory, memory such as a database that is accessible to the condition management computer 116, etc.). In some embodiments, the condition management computer 116 may be configured to communicate any suitable combination of the data received during the first and/or second enrollment processes to the processing network computer 112 which may store this data for subsequent use. By way of example, the condition management computer 116 may generate and transmit a mapping of the payment credential, blockchain address, and contact information to the processing network computer 112. The condition management computer 116 and/or the processing network computer 112 may be configured to store the mapping for subsequent use. It may be the case that the condition management computer 116 must first verify that one or more blockchain tokens are associated with the user's blockchain address before a mapping is generated and/or transmitted to the processing network computer. Generally, if the condition management computer 116 is able to determine that the user cannot meet all of the set of conditions based at least in part on the blockchain data associated with the blockchain address, then the condition management computer 116 may transmit an indication to the user that his enrollment was unsuccessful and/or he is not eligible for the offer. For example, the condition management computer 116 may determine from the set of conditions that in order to be eligible for the offer, the user's blockchain address must hold a blockchain token indicating a home purchase occurring the last 6 months. If the user's blockchain address does not hold this type of blockchain token and/or the purchase is determined from the blockchain token to have occurred later than the last 6 months, the condition management computer 116 may transmit an indication that the user's enrollment was unsuccessful and/or that the user is not eligible for the offer.

After enrollment, the user 102 may use the user device 104 to pay for a goods or services at a resource provider such as a merchant. The merchant may operate a resource provider computer 108 and/or an access device 106. The resource provider computer 108 may communicate with an authorizing entity computer 114 operated by an issuer, via a transport computer 110 operated by an acquirer and the processing network computer 112 operating as part of a payment processing network.

The processing network computer 112 may include data processing subsystems, networks, and operations used to support and deliver authorization services, exception file services, and clearing and settlement services. An exemplary processing network may include VisaNet™ (also referred to as a “payment processing network”). Payment processing networks such as VisaNet™ are able to process credit card transactions, debit card transactions, and other types of commercial transactions. VisaNet™, in particular, includes a VIP system (Visa Integrated Payments system) which processes authorization requests and a Base II system which performs clearing and settlement services. The payment processing network may use any suitable wired or wireless network, including the Internet.

A typical payment transaction flow using a user device 104 at an access device 106 can be described as follows. It should be appreciated that at transaction time, the user device 104 may be a mobile communications device or a payment device such as a physical payment card. The user device 104 and the access device 106 may perform any suitable operations for exchanging information. By way of example, the access device 106 may receive track 2 card data that includes a payment credential when the user device 104 is a physical payment card such as a debit and/or credit card. When the user device 104 is a mobile communications device, the access device 106 may receive a payment credential associated with the user. The access device 106 may, in some embodiments, be a website operated by the resource provider to enable transactions to be conducted with various users. The access device 106 may transmit transaction data comprising the track 2 data comprising a payment credential (e.g., PAN) or a separate payment credential (depending on the use case) with additional transaction data (e.g., price, merchant name, merchant identifier, etc.).

The resource provider computer 108 may receive this information from the access device 106 via an external communication interface. The resource provider computer 108 may then generate an authorization request message that includes at least a portion of the transaction data received from the access device 106 and electronically transmits this message to a transport computer 110. The transport computer 110 may then receive, process, and forward the authorization request message to a processing network computer 112.

In general, prior to the occurrence of a credit or debit-card transaction, the processing network computer 112 has an established protocol with each issuer on how the issuer's transactions are to be authorized. In some cases, such as when the transaction amount is below a threshold value, the processing network computer 750 may be configured to authorize the transaction based on information that it has about the user's account without generating and transmitting an authorization request message to the authorizing entity computer 760. In other cases, such as when the transaction amount is above a threshold value, the processing network computer 750 may receive the authorization request message, determine the issuer associated with the user device 710, and forward the authorization request message for the transaction to the authorizing entity computer 760 for verification and authorization. Once the transaction is authorized, the authorizing entity computer 760 may generate an authorization response message (that may include an authorization code indicating the transaction is approved or declined) and transmit this electronic message via its external communication interface to processing network computer 750.

The processing network computer 112 may obtain the payment credential from the authorization response message to determine (e.g., by the processing network computer or by request to the condition management computer 116) whether the payment credential (e.g., the user's account number) is associated with one or more sets of conditions (corresponding to one or more offers for which the user was previously enrolled). If a set of conditions is determined to be associated with the payment credential (e.g., by the processing network computer 112 and/or the condition management computer 116), the processing network computer 112 may determine if all of the conditions of the set are met. As described throughout, the conditions may vary depending on the particular use case, but generally, a condition may be based at least in part on transaction data values (e.g., does the transaction amount exceed a threshold value defined by the conditions), historical transaction data variables (e.g., has the payment credential been used for past transaction to a particular merchant that, when aggregated exceed a threshold value defined by the conditions), blockchain data (e.g., does one of the blockchain tokens associated with the blockchain address meet a condition, does data provided by one or more blockchain oracles/smart contracts meet a condition, etc.), or any suitable combination of the above.

If the processing network computer 112 determines that all of the conditions of the set have been met, the processing network computer 112 may be configured to perform, or cause the performance of the one or more specified operations. By way of example, if the user is to receive a benefit such as a statement credit in response to meeting the conditions of an offer, the processing network computer 112 may execute any suitable operations to cause a statement credit (e.g., 20% of the purchase price as defined by the operations associated with the set of conditions previously specified by a resource provider) to be applied to the user's financial account (e.g., managed by the authorizing entity computer 114).

The processing network computer 112 may then forward the authorization response message to the transport computer 110, which in turn may then transmit the electronic message to comprising the authorization indication to the resource provider computer 108, and then to the access device 106.

At the end of the day or at some other suitable time interval, a clearing and settlement process between the resource provider computer 108, the transport computer 110, the processing network computer 112, and/or the authorizing entity computer 114 may be performed on the transaction.

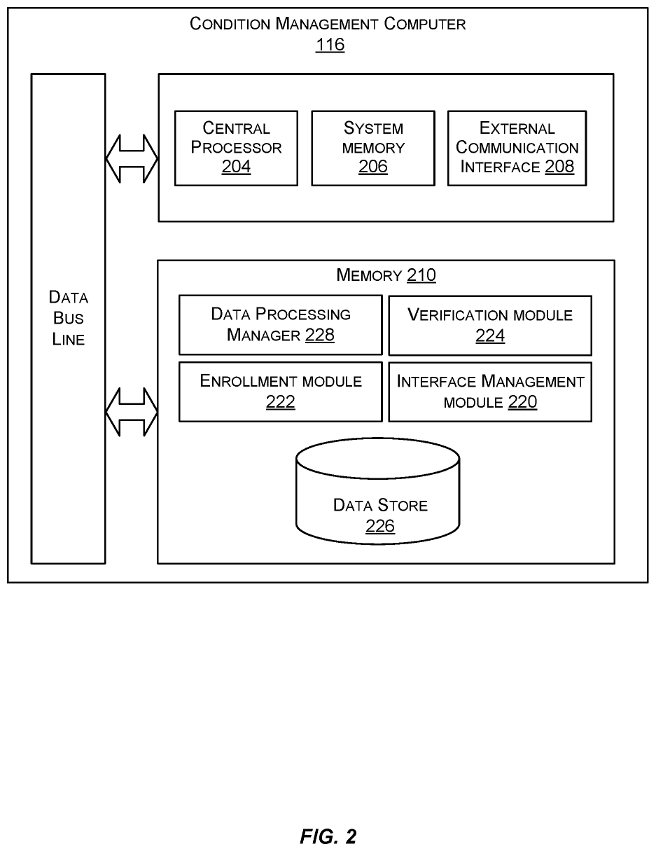

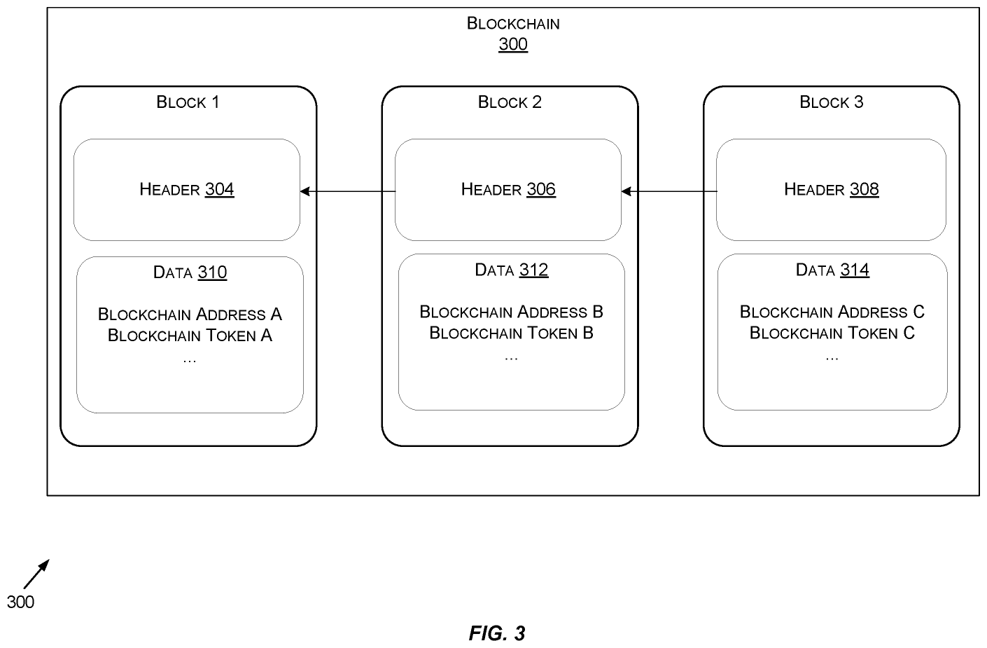

FIG. 2 shows a block diagram of an exemplary condition management computer 116, according to some embodiments. The condition management computer 116 may be a server computer that is the same or different from the processing network computer 112 of FIG. 1. The condition management computer 116 is illustrated as comprising a plurality of hardware and software modules (220-228). However, it should be appreciated that this is provided for illustration purposes only, that one or more of the modules and associated functionality may be provided and/or performed by the same or different components or by processing network computer 112. Moreover, a condition management computer 116 that implements at least a portion of the functionality described herein may have additional components or a lesser number of components than depicted in FIG. 3. Additionally, some of the modules may operate on a separate computer (e.g., the processing network computer 112).

The condition management computer 116 is shown as comprising a processor 204, system memory 206 (which may comprise any combination of volatile and/or non-volatile memory such as, for example, buffer memory, RAM, DRAM, ROM, flash, or any other suitable memory device), and an external communication interface 208. Moreover, one or more of the modules 220-228 may be disposed within one or more of the components of the memory 210, or may be disposed externally. As was noted above, the software and hardware modules shown in FIG. 2 (and other systems described herein) are provided for illustration purposes only, and the configurations are not intended to be limiting. The processor 204, system memory 206, and/or external communication interface 208 may be used in conjunction with any of the modules described below to provide a desired functionality. Some exemplary modules and related functionality is now described.

In some embodiments, the interface management module 220 may be configured to provide one or more interfaces with which a resource provider and/or user (e.g., the user 102 of FIG. 1) may provide input. The resource provider may access one or more interfaces provided by the interface management module 220 via sites hosted by the interface management module 220. The one or more interface provided by the interface management module 220 may be associated with a first enrollment process to be performed with a resource provider. In some embodiments, the resource provider may access the one or more interfaces via an application (e.g., a web browser, a marketing application, etc.) operating on the resource provider computer 108 of FIG. 1. At least some of the interfaces provided by the interface management module 220 may correspond to a second enrollment process to be performed with a user device. The user 102 may access these interfaces using the user device 104 (or any suitable device) using a link, a URL address, or the like provided to the user (e.g., via an advertisement provided via an application operating on the user device 104, via an electronic communication sent to the user device 104 and/or an email address associated with the user, etc.).

The interface management module 220 may be configured to receive data (e.g., one or more sets of conditions corresponding to one or more operations to be performed) from the resource provider via the interfaces associated with the first enrollment process. The interface management module 220 may be configured to receive data (e.g., a blockchain address, a payment credential, contact information associated with the user such as an email address or a mobile phone number, or any suitable combination of the above) from the user device 104 via the interfaces associated with the second enrollment process.

In some embodiments, the interface management module 220 may be configured to present any suitable data previously received from a resource provider at an interface accessible to the user device 104. This may be referred to as an offer advertisement. In some embodiments, the offer advertisement may be provided via a digital wallet application operating on the user device 104, via an electronic message provided to the user's email address, by a website hosted by the interface management module 220 or by any suitable electronic means. In some embodiments, the interface management module 220 may assign a unique identifier (hereinafter referred to as an “offer identifier”) to the set of conditions and one or more associated operations as part of the first enrollment process.

The interface management module 220 may store the set of conditions, corresponding operations, and/or data received from the resource provider computer 108 and/or the user device 104 within data store 230 for subsequent processing.

In some embodiments, the enrollment module 222 may be configured to receive (e.g., from the interface management module) or obtain (e.g., from the data store 226) any suitable data provided by a resource provider computer as part of a first enrollment process (enrollment of an offer associated with a set of conditions and one or more operations to be performed if the set of conditions are met) and/or any suitable data provided by a user device as part of a second enrollment process (e.g., a blockchain address associated with the user 102, a payment credential such as an account number or other suitable identifier from which an association to a financial account may be ascertained, and/or contact information associated with the user 102 such as phone number). In some embodiments, the data received from the user device 104 may include the offer identifier corresponding to the offer to which the user device 104 is enrolling. The enrollment module 222 may be configured to obtain the set of conditions associated with the offer identifier. Once obtained, the enrollment module 222 may perform any suitable operation to determine whether one or more of the conditions of the set are met. These operations may include obtaining blockchain data corresponding to one or more blockchain tokens that are associated with the blockchain address provided by the user device 104. The condition management computer 116 may operate as an blockchain node of a blockchain network (not depicted) such as, but not limited to, an Ethereum blockchain network or the enrollment module 222 may be configured to communicate with the blockchain computer 118 of FIG. 1 which may operate as a blockchain node of the blockchain network.

In some embodiments, the enrollment module 222 may be configured to verify that at least one of the set of conditions associated with the offer identifier is met based at least in part on the blockchain data. By way of example, the resource provider may have specified that one condition that is to be met before the one or more operations are to be performed (e.g., a discount, statement credit, issuance of a subsequent blockchain token) is that a particular type of blockchain token has been previously associated with the blockchain address of the user. It should be appreciated that any suitable blockchain data (e.g., one or more blockchain tokens, data provided by a decentralized oracle/smart contract of the blockchain, etc.) may be utilized to determine, at least in part, whether a condition has been met. In some embodiments, when the enrollment module 222 determines that the user is eligible to enroll in the offer (e.g., based at least in part on one or more conditions being met such as having a blockchain token indicating home ownership associated with the user's blockchain address), the enrollment module 222 may generate a mapping of the payment credential, blockchain address, and contact information in data store 226. In some embodiments, the enrollment module 222 may be configured to transmit any suitable portion of this mapping and/or data to the processing network computer 112. Generally, if the enrollment module 222 is able to verify that the user is not eligible for the offer based on the set of conditions (e.g., the specified blockchain token type is not found to be associated with the user's blockchain address, the token doesn't meet additional conditions, etc.), then the enrollment module 222 may be configured to cause the data processing manager to transmit an indication to the user (e.g., utilizing the user's contact information such as his mobile phone number) that his enrollment was unsuccessful and/or he is not eligible for the offer.

In some embodiments, the enrollment module 222 may be configured to provide an indication to the data processing manager 228 as to whether the first enrollment process and/or the second enrollment process was successful or unsuccessful. In some embodiments, the data processing manager 228 may be configured to provide an indication (e.g., an email, text message, push notification, dialog box, webpage, etc.) to a resource provider computer indicating whether the enrollment of an offer (the first enrollment process) was successful or unsuccessful. Similarly, the data processing manager 228 may be configured to provide an indication (e.g., an email, text message, push notification, dialog box, webpage, etc.) to a user device indicating whether an association (enrollment) between the user and an offer was successful or unsuccessful.

In some embodiments, the verification module 224 (operating on the condition management computer 116 or the processing network computer 112) may be configured to receive a request to verify whether a set of conditions are met based on any suitable combination of blockchain data associated with the user's blockchain address and/or transaction data initially received in an authorization request or response message. In some embodiments, receipt of an authorization request message and/or an authorization response message may be considered a request to verify whether a set of conditions are met based on any suitable combination of blockchain data associated with the user's blockchain address and/or transaction data initially received in an authorization request or response message. As a non-limiting example, an authorization response message may be received (by the processing network computer 112) containing transaction data including a payment credential. The transaction data may be forwarded to the verification module 224. The verification module 224 may be configured to utilize the payment credential to retrieve one or more sets of conditions and/or operations corresponding to one or more offers with which the payment credential was previously associated (e.g., as part of the second enrollment process discussed above).

The verification module 224 may be configured to perform any suitable operation to determine whether a set of conditions associated with an offer have been met. In some embodiments, the verification module 224 may utilize the payment credential to look up, from the mapping stored in the data store 226, a blockchain address associated with the payment credential. Once retrieved, the blockchain address may be utilized to obtain blockchain data (e.g., one or more blockchain tokens associated with the blockchain address). The verification module 224 may utilize any suitable combination of the transaction data and/or the blockchain data to determine whether the set of conditions have been met. In some embodiments, if the set of conditions are met, the verification module 224 may provide data indicating the same to the data processing manager 228 which in turn may be configured to provide an electronic notification (e.g., an email, text message, push notification, etc.) to the user utilizing the user's contact information contained in the mapping. As a non-limiting example, this electronic notification may indicate that an operation associated with a set of conditions was performed in response to determination that the set of conditions were met. By way of example, the electronic notification may indicate that a statement credit has been applied for a particular amount, that a blockchain token has been issued, or the like.

In some embodiments, the data processing manager 228 may be further configured to transmit any suitable data (e.g., to a resource provider computer) in response to receiving an indication from the verification module 224 that a set of conditions were met. In some embodiments, the verification module 224 may provide contact information associated with a resource provider that provided the set of conditions during a first enrollment process. The data processing manager 228 may transmit an indication that the set of conditions were met to the resource provider computer as well as the blockchain address associated with the user (as determined from the mapping of data store 226. The resource provider computer may be configured to generate a blockchain token in response to receiving this indication. The resource provider comptuer may be configured to perform additional operations to cause the blockchain token to be generated by another computer and/or associated with the user's blockchain address.

FIG. 3 depicts an example of a portion of a blockchain 300 according to some embodiments. The depicted portion of the blockchain 300, may include a number of blocks 1, 2, 3, each block including respective headers 304, 306, and 308. Each header may include data elements including version numbers, previous block hashes, merkle roots, and timestamps. Each block may also include reliability association data.

For example, data 310 may include blockchain address A and blockchain token A, data 312 may include blockchain address B and blockchain token B, and data 314 may include blockchain address C and blockchain token C. Blockchain tokens A, B, and C, may be in any suitable form (e.g., an ERC-20 token, an ERC-721 token) depending on the particular blockchain utilized. Each blockchain token may represent a digital asset that is maintained within a blockchain and, in this case, associated with a particular user. In some embodiments, the blockchain addresses A, B, and C may be the same blockchain address or differing blockchain addresses.

As a non-limiting example, blockchain address A, B, and C may refer to the same address associated with a single blockchain user. Each of the blockchain tokens A, B, and C may represent a user's ownership of an asset (e.g., a title of property such as a home, a car, etc.), a financial instrument of the user (e.g., one or more stocks, bonds, etc.), and/or a membership of the user (e.g., a loyalty program membership, membership in an organization, etc.). The blockchain tokens A, B, and C may include any suitable data such as a token identifier (e.g., a string, an alphanumeric code, etc.) that identifies the specific token and/or a type associated with the token (e.g., an ownership token, a financial instrument token, a membership token, a user identity token (e.g., a birth certificate token), or the like). The blockchain tokens may include data such as a property address, a purchase price, a purchase date, a type of financial instrument, a membership number, a membership type, or the like. Blockchain tokens A, B, and C may conform to a predetermined and public specification. For example, any of the blockchain tokens A, B, and C may be in the form of an ERC-20 token, an ERC-721 token, or any suitable token associated with an Ethereum blockchain. It should be appreciated that Ethereum is used merely for illustrative purposes. It is contemplated that a blockchain token may take any suitable form based at least in part on the particular blockchain being utilized.

Any suitable number of blocks may be included in the blockchain 300, and each block may be accessible by any node of the blockchain network (e.g., the blockchain computer 118 and/or the condition management computer 116 of FIG. 1 operating as a blockchain node.

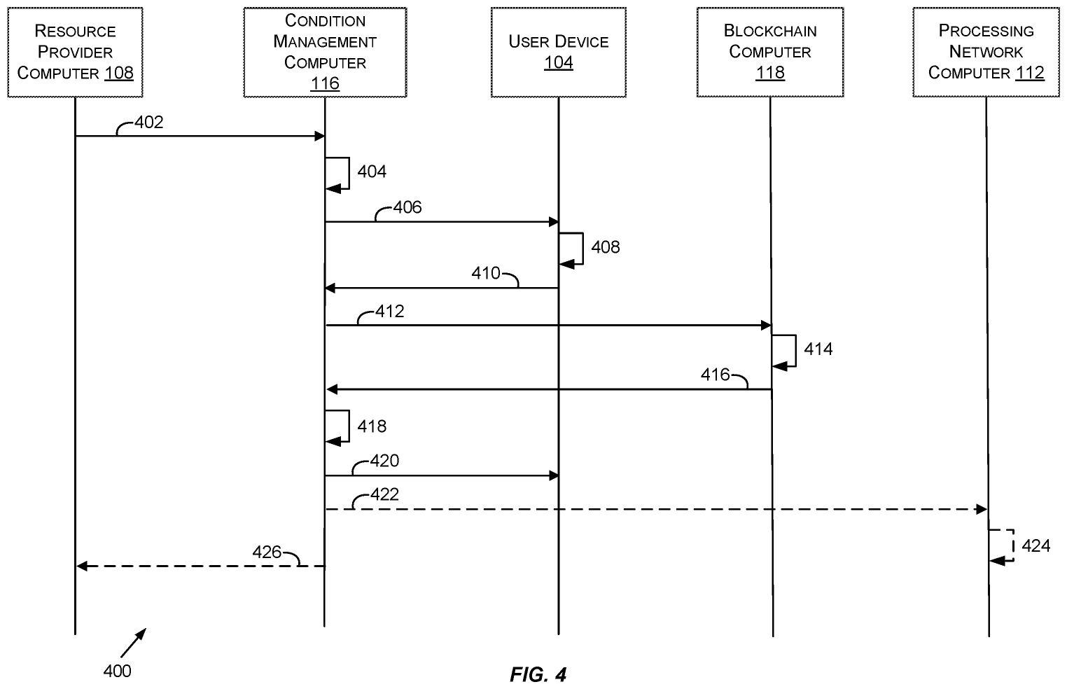

FIG. 4 depicts a flow diagram 400 illustrating a first and second enrollment process, in accordance with at least one embodiment. A first enrollment process may begin at 402, where a resource provider may utilize a resource provider computer to access an interface provided by the condition management computer 116. In some embodiments, the interface may be configured to obtain offer information from the resource provider. By way of example, the resource provider may provide offer information including a set of conditions and corresponding operations to be performed (e.g., statement credits, blockchain token assignment, etc.) should those conditions be met. In some embodiments, the offer information may include a resource provider identifier (e.g., an IP address of the resource provider computer, a resource provider name, and alphanumeric identifier, etc.) with which the offeror is distinguishable from other offerors. The offer information provided at the interface by the resource provider may be transmitted to the condition management computer 116 (e.g., the interface management module 220 of FIG. 2).

At 404, the condition management computer 116 may store the data received from the resource provider computer 108 in any suitable storage location (e.g., the data store 226 of FIG. 2).

As part of a separate process, the resource provider may make consumers aware of the offers they have previously enrolled using the first enrollment process. By way of example, a resource provider such as a merchant may advertise an offer on traditional ad real estate such as online ads, search ads, street posters, email messages, push notifications, text messaging, or the like. In some embodiments, the advertisement may be presented at a user device 104 via a digital wallet application operating on the user device 104. The advertisement may include navigation information such as a hyperlink, a QR code, a URL address, or the like that, when utilized by the user, navigates the user to an interface associated with enrolling the user.

Returning to the FIG. 4, the second enrollment process may begin at 406, after the first enrollment process was performed. The second enrollment process may include verification of one or more blockchain tokens for the purpose of determining offer edibility. At 406, an advertisement may be provided by the condition management computer 116. It should be appreciated that another computing device may provide this advertisement to the user device 104.

At 408, the user device 104 may be utilized to navigate to an interface associated with enrolling the user in the offer. The interface may be in any suitable form. In some embodiments, the interface may include interface elements that may be utilized to input a blockchain address associated with the user, a payment credential associated with the user (e.g., a payment card number, a personal account number, etc.), and contact information such as a mobile phone number associated with the user, and/or the like. In some embodiments, a digital wallet application operating at the user device 104 may have previously obtained such data from the user. Accordingly, in some embodiments, the digital wallet application may cause the user device 104 to automatically transmit such data to the condition management computer 116 on selection of the navigation information provided in the advertisement.

At 410, the user device 104 transmits the blockchain address associated with the user, a payment credential associated with the user, and contact information associated with the user to the condition management computer 116 in an enrollment request message. In some embodiments, an offer identifier associated with the offer information initially presented at the user device 104 may be included in this transmission.

At 412, the condition management computer 116 may be configured to query a blockchain computer 118 (operating as a blockchain node of a blockchain network) for any blockchain tokens associated with the blockchain address received at 410. It should be appreciated that the condition management computer 116 may itself operate as a blockchain node and thus, it may directly obtain from the blockchain, blockchain tokens that have been previously associated with the blockchain address received at 410.

At 414, the blockchain computer 118 may determine what, if any, blockchain tokens are associated with the blockchain address provided at 412.

At 416, the blockchain computer may transmit the blockchain tokens (or corresponding identifiers/indicators of the blockchain tokens) to the condition management computer 116.

At 418, the condition management computer 116 may determine at least one of the conditions associated with the offer has been met. This determination may be made based on the blockchain data received at 416. As a non-limiting example, the offer may correspond to an offer to provide 20% of a user's purchase price as a statement credit when the user shops as a particular merchant (e.g., a merchant associated with the resource provider) if the user's blockchain address is associated with a blockchain token that indicates the user purchased a home (e.g., in the last year, in the last six months, etc.). It the blockchain data received at 416 includes such a blockchain token or an indication that such a blockchain token is associated with the user's blockchain address, the condition management computer 116 may determine that at least one condition of the set of conditions has been met. In response, the condition management computer 116 may store a mapping of the blockchain address, the payment credential, and the contact information. In some embodiments, the mapping may further include the offer information (e.g., an identifier of the resource provider, the set of conditions of the offer, and the one or more operations to be performed should the conditions be met). The condition management computer 116 may be configured to verify whether at least one condition can never be met based at least in part on the blockchain data received at 416.

If the condition management computer 116 has generated the mapping or determined that the conditions can never be met based at least in part on the blockchain data received at 416, the condition management computer 116 can cause a notification to be provided to the user device 104 (e.g., by a third party notification provider such as an email server, an SMS server, a push notification server, or the like). In the former case, the user device 104 may display an indication that the second enrollment process was successful (e.g., “Congratulations! You will now get 20% of your next purchase with merchant X as a statement credit!”). In the latter case, the user device 104 may provide an indication that the second enrollment process was unsuccessful (e.g., “Sorry! You're not eligible for this offer.”). If the second enrollment process is unsuccessful, the condition management computer 116 may cease processing the data received at 410.

If the second enrollment process was successful then, in some embodiments, the condition management computer 116 may provide the mapping or any suitable combination of the blockchain address, the payment credential, the user's contact information, and the offer information to the processing network computer at 422. The processing network computer 112 may store the data in local memory or in a database accessible to the processing network computer 112.

In some embodiments, the condition management computer 116 may be configured to provide an electronic notification to the resource provider computer 108 at 426 to indicate that the user of user device 104 is eligible for the offer. This notification may include the offer identifier, the blockchain address associated with the user, and/or the user's contact information. Although not depicted, in some embodiments, in response to receiving the data at 426, the resource provider computer 108 may cause the blockchain computer 118 to generate a blockchain token associated with the offer and transfer the generated blockchain token to the blockchain address associated with the user. The blockchain token generated may represent the user's eligibility with respect to the offer. In at least one embodiment, the blockchain token may include the offer identifier. In these scenarios, the indication that the second enrollment was successful may not be sent to the user device 104 at 420, but rather the indication may be sent by the resource provider computer 108 once confirmation has been received from the blockchain computer 118 that a blockchain token representing the user's eligibility in a particular offer has been associated with the user's blockchain address.

In some embodiments, it should be appreciated that the processing network computer 112 may perform the functionality described above in connection with the condition management computer 116, the blockchain computer 118, and the processing network computer 112.

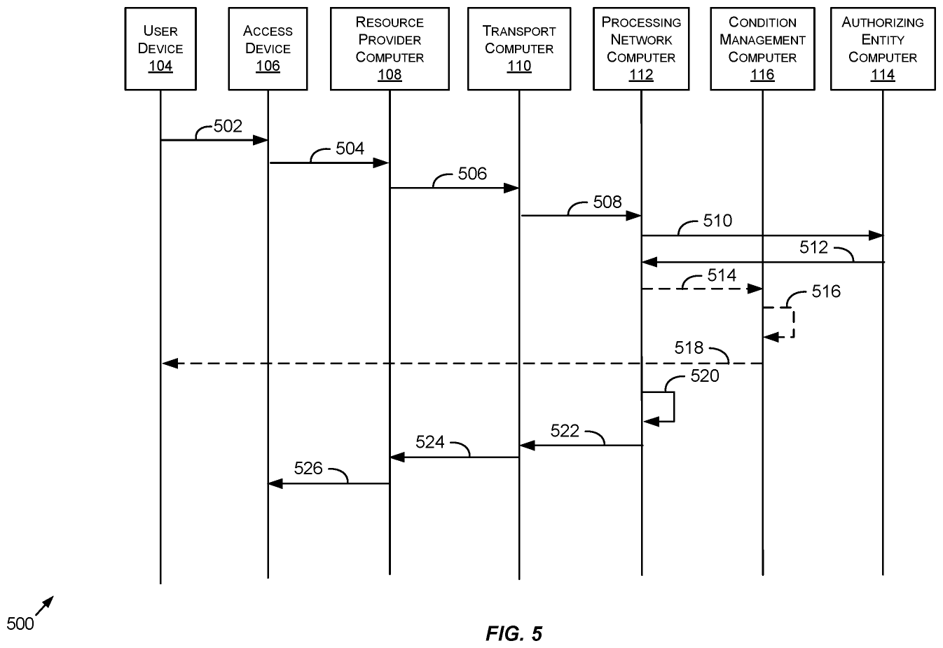

Moving on to FIGS. 5-7 which depict a number of flow diagrams illustrating examples methods for processing a transaction. In some examples described in connection with FIGS. 5-7 the payment network computer 112 and/or the condition management computer 116 is described as interacting with the blockchain computer 118 to obtain blockchain data and/or third-party data after an authorization response message is received. However, in some embodiments, this interaction (and/or a determination on whether conditions associated with the payment credential have been met) may occur in response to receiving an authorization request message. For example, upon receipt of an authorization request message indicating that a particular type of transaction was conducted at a particular type of merchant, some portion of the transaction from the authorization request message (or the whole of the authorization request message) can be utilized (e.g., by the processing network computer 112 and/or the condition management computer 116) to identify a set of conditions associated with the payment credential. A blockchain address that is associated with the payment credential may be retrieved and used to obtain blockchain data and/or third-party data (e.g., from the blockchain computer 118). Any suitable combination of the transaction data received in the authorization request message, the blockchain data, and/or the third-party data may be utilized to determine whether the predetermined set of conditions is met.

FIG. 5 depicts a flow diagram illustrating example method 500 for transaction processing during which a user receives a credit (e.g., a statement credit applied to the user's financial account) based at least in part on meeting a set of conditions associated with an offer, according to some embodiments. The operations depicted in FIG. 5 may be performed subsequent to the first enrollment process and second enrollment process discussed in connection with FIG. 4. It should be appreciated that at transaction time, the user device 104 may be a mobile communications device or a payment device such as a physical payment card.

The method 500 may begin at 502, the user device 104 and the access device 106 may perform any suitable operations for exchanging information. By way of example, the access device 106 may receive track 2 card data that includes a payment credential when the user device 104 is a physical payment card such as a debit and/or credit card. When the user device 104 is a mobile communications device, the access device 106 may receive a payment credential associated with the user. The access device 106 may be a website operated by the resource provider to enable transactions to be conducted with various users.

At 504, the access device 106 may transmit transaction data comprising the track 2 data comprising a payment credential (e.g., PAN) or a separate payment credential (depending on the use case) with additional transaction data (e.g., price, merchant name, merchant identifier, etc.).

The resource provider computer 108 may receive this information from the access device 106 via an external communication interface. At 506, the resource provider computer 108 may generate an authorization request message that includes at least a portion of the transaction data received from the access device 106 and electronically transmits this message to a transport computer 110. The transport computer 110 may receive and process the message. At 508, the transport computer 110 may forward the authorization request message to the processing network computer 112.

In general, prior to the occurrence of a credit or debit-card transaction, the processing network computer 112 has an established protocol with each issuer on how the issuer's transactions are to be authorized. In some cases, such as when the transaction amount is below a threshold value, the processing network computer 112 may be configured to authorize the transaction based on information that it has about the user's account without generating and transmitting an authorization request message to the authorizing entity computer 114. In other cases, such as when the transaction amount is above a threshold value, the processing network computer 112 may receive the authorization request message, determine the issuer associated with the payment credential received at 508 as part of the authorization request message, and forward the authorization request message for the transaction to the authorizing entity computer 114 for verification and authorization at 510. At 512, once the transaction is authorized, the authorizing entity computer 114 may generate an authorization response message (that may include an authorization code indicating the transaction is approved or declined) and transmit this electronic message via its external communication interface to processing network computer 112.

The processing network computer 112 (when performing the functions associated with a condition management computer 116) may obtain the payment credential from the authorization response message to determine (e.g., by the processing network computer or by request to the condition management computer 116) whether the payment credential (e.g., the user's account number) is associated with one or more sets of conditions (corresponding to one or more offers for which the user was previously enrolled via the second enrollment process discussed in connection with FIG. 4. If a set of conditions is determined to be associated with the payment credential (e.g., by the processing network computer 112 and/or the condition management computer 116), the processing network computer 112 may determine if all of the conditions of the set are met. As described throughout, the conditions may vary depending on the particular use case, but generally, a condition may be based at least in part on transaction data values, historical transaction data variables, blockchain data (e.g., such as one or more blockchain tokens associated with the user's blockchain account, one or more blockchain oracles/smart contracts, etc.), or any suitable combination of the above. Accordingly, in some embodiments, the processing network computer 112 may retrieve blockchain data from the blockchain computer 118 that is associated with the blockchain address associated with the payment credential. This blockchain data may be utilized to determine whether the set of conditions has been met. It should be appreciated that although this functionality is depicted as occurring subsequent to receipt of the authorization response message at 512, it may additionally or alternatively be executed in response to receipt of the authorization request message at 508.

If the processing network computer 112 determines that all of the conditions of the set have been met, the processing network computer 112 may be configured to perform, or cause the performance of the one or more specified operations. By way of example, if the user is to receive a benefit such as a statement credit in response to meeting the conditions of an offer, the processing network computer 112 may execute any suitable operations to cause a statement credit (e.g., 20% of the purchase price as defined by the operations associated with the set of conditions previously specified by a resource provider) to be applied to the user's financial account (e.g., managed by the authorizing entity computer 114).

In some embodiments, the condition management computer 116 may be different from the processing network computer 112 and the condition management computer 116 may be configured to determine whether the set of conditions has been met. In these use cases, the processing network computer 112 may send any suitable portion of the authorization request message or authorization response message to the condition management computer 116 at 514 (e.g. in response to receipt of the authorization request message and/or receipt of the authorization response message).

At 516, the condition management computer 116 may obtain the payment credential from the data received at 514, and determine whether a set of conditions associated with the payment credential (corresponding to previously defined offer provided by the resource provider) has been met. As discussed throughout, the determination as to whether the set of conditions of the offer have been met may depend on any suitable portion of the transaction data of the authorization response message and/or blockchain data associated with the user. If blockchain data is required to determine whether the set of conditions have been met, the condition management computer 116 may retrieve the user's blockchain address from the mapping utilizing the payment credential. Using the blockchain address, the condition management computer 116 may retrieve directly, or via the blockchain computer 118 (not depicted here), to obtain blockchain data (blockchain tokens) associated with the blockchain account. Although these conditions are discussed as being checked after receipt of the authorization response message, it should be appreciated that this functionality may be performed in response to receiving the authorization request message at 508. Accordingly, in these cases, the condition management computer 116 may retrieve directly, or interact with the blockchain computer 118 (not depicted here), to obtain blockchain data (blockchain tokens) associated with the blockchain account in response to receiving the authorization request message at 508.

At 518, the condition management computer 116 may optionally provide an electronic notification to the user device 104 when the conditions have been met. For example, one notification may include text such as “Congratulations! You received $12.00 as a statement credit based on your recent transaction of $60.00 at Merchant X.” If the condition management computer 116 and/or processing network computer 112 determine that the set of conditions of an offer have not yet been met (e.g., the user has not reached a threshold aggregate purchase amount based on historical transactions between the user and a particular merchant) then the transaction processing of FIG. 5 may continue to 522.

If however, the conditions of an offer have been met, the processing network computer 112 may perform one or more operations associated with the offer at 520. One operation may include transmitting an electronic notification to the user device 104. In some embodiments, this electronic notification may be provided by the processing network computer 112 in lieu of the notification transmission depicted at 518. The processing network computer 112 or the condition management computer 116 may identify (e.g., from the data provided in the first enrollment process described in FIG. 4) one or more operations to be performed when a set of conditions are determined to have been met. In some embodiments, the condition management computer 116 may provide an offer identifier associated with the set of conditions, and the processing network computer 112 may utilize the offer identifier to obtain the set of operations to be performed. In the use case described in FIG. 5, the set of operations may indicate that any suitable instructions are to be executed to cause a statement credit of $12.00 to be applied to the user account (e.g., as identified by the payment credential). As yet another example, an operation associated with an offer may indicate that a blockchain token associated with the offer (e.g., via an offer identifier) and the user's blockchain account is to be deleted. For example, the user's blockchain address may hold a blockchain token indicating the user's offer eligibility. If the offer is, for example, a one-time use offer, then the processing network computer 112 or the condition management computer 116 may request

At 522, the processing network computer 112 may then forward the authorization response message to the transport computer 110, which in turn may then transmit the electronic message to comprising the authorization indication to the resource provider computer 108 at 524. The resource provider computer 108 may then forward the message to the access device 106 at 526.

At the end of the day or at some other suitable time interval, a clearing and settlement process between the resource provider computer 108, the transport computer 110, the processing network computer 112, and/or the authorizing entity computer 114 may be performed on the transaction.

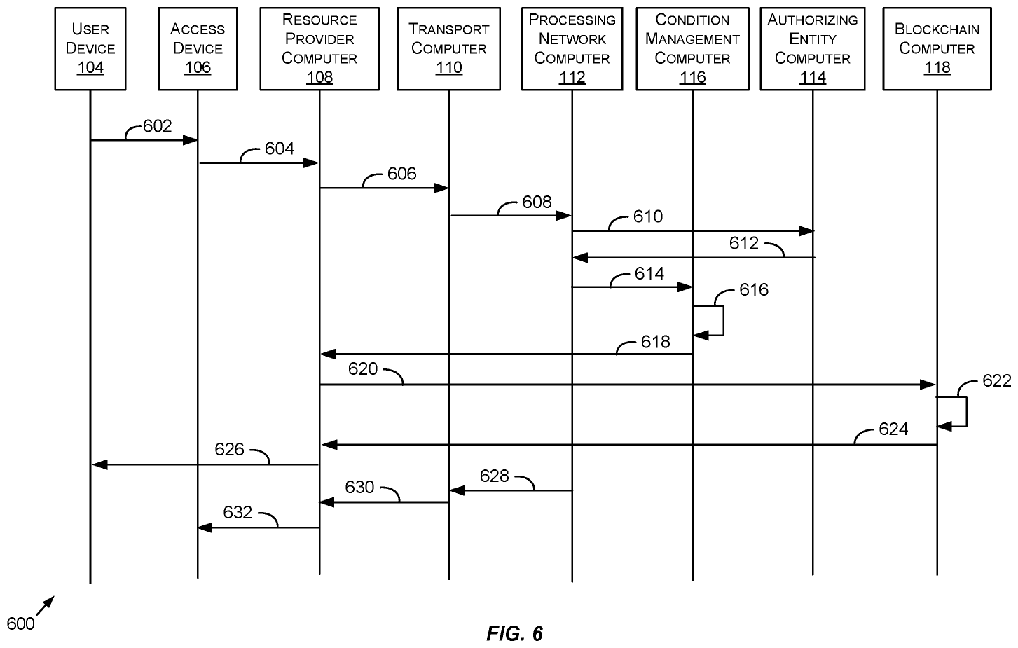

FIG. 6 depicts a flow diagram illustrating example method 600 for transaction processing during which the user receives a blockchain token based at least in part on meeting a set of conditions associated with an offer, according to some embodiments. Generally, the steps 602-612 may correspond to the steps 502-512 discussed above in connection with FIG. 5.

In some embodiments, after receiving the authorization response message at step 612, the processing network computer 112 (when performing the functions associated with a condition management computer 116) may obtain the payment credential from the authorization response message to determine whether the payment credential (e.g., the user's account number) is associated with one or more sets of conditions (corresponding to one or more offers for which the user was previously enrolled via the second enrollment process discussed in connection with FIG. 4). If a set of conditions is determined to be associated with the payment credential, the processing network computer 112 may determine if all of the conditions of the set are met. As described throughout, the conditions may vary depending on the particular use case, but generally, a condition may be based at least in part on transaction data values, historical transaction data variables, blockchain data (e.g., such as one or more blockchain tokens associated with the user's blockchain account, one or more blockchain oracles/smart contracts, etc.), or any suitable combination of the above.

Although FIG. 6 illustrates an example in which the conditions are checked after receipt of the authorization response message, it should be appreciated that this functionality may be performed in response to receiving the authorization request message at 508. By way of example, the payment credential from an authorization request message received at 608 may be obtained and a corresponding set of conditions determined. The condition management computer 116 may retrieve directly, or interact with the blockchain computer 118 (not depicted here), to obtain blockchain data (blockchain tokens) associated with the blockchain account after the authorization request message is received but before the authorization response message has been received.

In some embodiments, the condition management computer 116 may be configured to perform the operations for determining whether transaction data and/or blockchain data have met a set of conditions associated with a payment credential. In these embodiments, the processing network computer 112 may transmit the transaction data (or the authorization response message) to the condition management computer 116 at 614.

At 616, the condition management computer 116 may whether all of a set of conditions associated with an offer have been met. In some embodiments, the condition management computer 116 may retrieve directly, or interact with the blockchain computer 118 to obtain blockchain data (blockchain tokens) associated with the blockchain account. The blockchain data may be utilized to determine whether the set of conditions have been met. Although depicted as occurring after the authorization request message was received, it should be appreciated that this functionality may be performed in response to receipt of the authorization request message at 608.

In some embodiments, the condition management computer 116 (or the processing network computer 112) may be configured to provide an electronic notification to the resource provider computer 108 at 618 to indicate that the user of user device 104 has met the conditions of a particular offer. This notification may include the offer identifier, the blockchain address associated with the user, and/or the user's contact information.

At 620, the resource provider computer 108 may transmit to a blockchain computer 118, the user's blockchain address and any suitable data related to generating a token. By way of example, the resource provider computer 108 may specify a type of blockchain token to be generated as well as provide any suitable data such as offer information (e.g., such as the offer identifier), a type of token to be generated, computer code for token generation, computer code for token destruction, and the like.

At 622, the blockchain computer 118 may be configured to generate a blockchain token (e.g., an ERC-20 token, an ERC-721 token) corresponding to the data received at 620. Once generated, the blockchain computer 118 may be associated with the user's blockchain address. In some embodiments, the blockchain token may correspond to access rights corresponding to a digital asset (e.g., a gaming feature such as a character, a level, a weapon, an object, or any suitable element of a gaming platform). As a non-limiting example, when the user spends more than $50 on a particular day at a particular merchant, in conformance with a previously provided offered associated with the merchant, the user may receive a collectible digital character that is represented by a particular blockchain token and/or type of blockchain token. The blockchain token may be utilized by a gaming platform to verify the user has rights to access a feature provided in the game such as the digital representation of the digital character.

At 624, the blockchain computer 118 may transmit an indication to the resource provider computer 108 that the requested blockchain token was generated and associated with the user's blockchain address.

At 626, the resource provider computer 108 may transmit any suitable data to the user device 104 to indicate the generation of the blockchain token. As a non-limiting example, the user device 104, upon receipt of the data at 626, may be configured to present a message “Congratulations! Your recent purchase at merchant X has qualified you to access character Y of the game Z!! Log in to game Z to access your new character!”

Generally, the steps 628-632 correspond to the steps 522-526 of method 500 described above in connection with FIG. 5. At the end of the day or at some other suitable time interval, a clearing and settlement process between the resource provider computer 108, the transport computer 110, the processing network computer 112, and/or the authorizing entity computer 114 may be performed on the transaction.

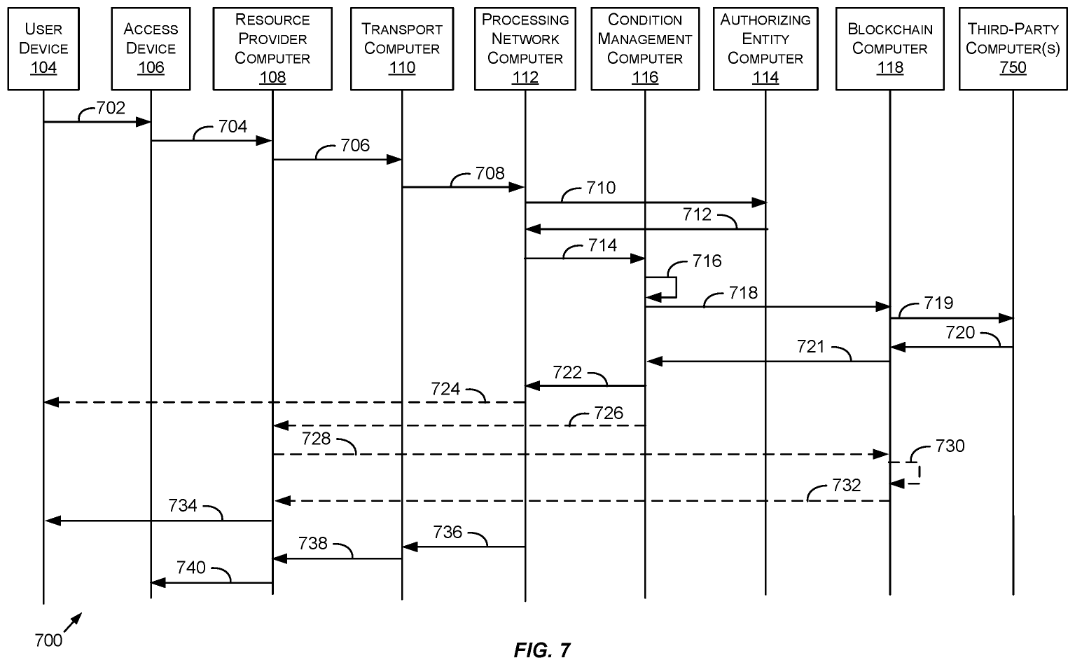

FIG. 7 depicts a flow diagram illustrating example method 700 for transaction processing during which the user receives a benefit based at least in part on third-party data collected via a smart contract of a blockchain. The steps 702-712 may correspond to the steps 502-512 and 602-612 discussed above in connection with FIGS. 5 and 6, respectively.

At 714, the processing network computer 112 may transmit the authorization response message (or any suitable portion of the transaction data received at 712 via the authorization response message) to the condition management computer 116.

At 716, the condition management computer 116 (or the processing network computer 112 operating as a condition management computer 116) may utilize a payment credential of the transaction data to lookup a blockchain address associated with the user of the payment credential.

At 718, the condition management computer 116 (or the processing network computer 112) may transmit, to the blockchain computer 118, a request for blockchain data (e.g., blockchain tokens) associated with the blockchain address retrieved at 716. In some embodiments, it should be appreciated that the processing network computer 112 may perform at least some of the functionality described in connection with condition management computer 116) and/or the blockchain computer 118. Similarly, in some embodiments, the condition management computer 116 may perform at least some of the functionality described in connection with blockchain computer 118.

At 719, the blockchain computer 118 may be configured to obtain third party data (e.g., weather reports, traffic reports, election results, sports statistics, game scores, stock market data, or any suitable data) via one or more API defined by one or more smart contracts of the blockchain and/or a smart contract associated with the blockchain token.

As an example, a user may enroll in an offer using the second enrollment process discussed above in connection with FIG. 4. At least one of the conditions for the offer may depend on third party data. For example, the offer may be that San Francisco residents may receive a discount (e.g., a 20% statement credit corresponding to a purchase price) for a transaction performed with merchant X within 24 hours after a particular San Francisco based sports team wins a championship game. In some embodiments, a smart contract may be generated to obtain third party data utilizing a number of APIs to obtain similar data (e.g., scores associated with the championship game). By way of example, at 719 data from five online sports data sources may be obtained based on the smart contract. Ground truth may be determined based at least in part on a majority consensus, that is if at least three of the online sports data sources provide data indicating the San Francisco based sports team won the championship game, then the smart contract will return data indicating the same. It should be appreciated that this third party data may be collected at 719 or at any suitable time. In some embodiments, data obtained via these smart contracts (e.g., a decentralized oracle) may be utilized to trigger blockchain token generation.

As a non-limiting example, the merchant may enroll the offer described off during a first enrollment process described in connection with FIG. 4. A smart contract may be generated and stored on the blockchain that obtains third party data related to at least one condition of the offer (e.g., did a particular sports team win the championship game) from a number of third party sources. In some embodiments, when the smart contract provides data indicating that the condition has been met, the blockchain computer 118 may be triggered to generate a blockchain token corresponding to the offer for any blockchain user that is associated with blockchain data (e.g., another blockchain token) that indicates the user's city of residence is San Francisco. When these users later perform a transaction at merchant X, the blockchain token may be identified as being associated with the user, and the operations associated with the offer may be performed.

Returning to the example provided in FIG. 7, the third-party data may be provided to the blockchain computer 118 at 720.

At 721, the blockchain computer 118 may return blockchain data associated with the blockchain address. The blockchain data may include one or more blockchain tokens and/or indications of the types of blockchain tokens that are associated with the blockchain address provided at 718 and the third party data obtained at 720.

In some embodiments, the condition management computer 116 may be configured to determine whether all of a set of conditions associated with an offer have been met based at least in part on the blockchain data and/or the third-party data received at 721 and/or the transaction data included in the authorization request message discussed in connection with step 708 and/or the transaction data included in the authorization response message discussed in connection with step 712. Alternatively, the condition management computer 116 may transmit the blockchain data to the processing network computer 112 which may be configured to determine whether all of the set of conditions associated with an offer have been met based on the data outlined above. It should be appreciated that the third-party data may be provided by the blockchain computer 118 at any suitable time, and not necessarily after the authorization response message has been received at 712. By way of example, this third-party data may be available prior to the transaction being initiated. Accordingly, the processing network computer 112 and/or the condition management computer 116 may obtain blockchain data and/or third party data at any suitable time (e.g., in response to receiving the authorization request message at 708, in response to receiving the authorization response message at 712, etc.).

The processing network computer 112 and/or the condition management computer 116 may be configured to perform one or more operations associated with the offer when it is determined the set of conditions associated with the offer have been met. By way of example, the processing network computer 112 (or the condition management computer 116) may be configured to provide an electronic notification to the user device 104 that a particular operation associated with an offer has been performed. For example, the notification may include text such as “Congratulations! You received $12.00 as a statement credit based on your recent transaction of $60.00 at Merchant X.”

In some embodiments, the processing network computer 112 (or the condition management computer 116) may be configured to provide an electronic notification to the resource provider computer 108 at 726 to indicate that the user of user device 104 has met the conditions of a particular offer. This notification may include the offer identifier, the blockchain address associated with the user, and/or the user's contact information.

At 728, the resource provider computer 108 may transmit to the blockchain computer 118, the user's blockchain address and any suitable data related to generating a token. By way of example, the resource provider computer 108 may specify a type of blockchain token to be generated as well as provide any suitable data such as offer information (e.g., such as the offer identifier), a type of token to be generated, computer code for token generation, computer code for token destruction, and the like.

At 730, the blockchain computer 118 may be configured to generate a blockchain token (e.g., an ERC-20 token, an ERC-721 token) corresponding to the data received at 620. Once generated, the blockchain computer 118 may be associated with the user's blockchain address. In some embodiments, the blockchain token may correspond to access rights corresponding to a digital asset (e.g., a gaming feature such as a character, a level, a weapon, an object, or any suitable element of a gaming platform). As a non-limiting example, when the user spends more than $50 on a particular day at a particular merchant, in conformance with a previously provided offered associated with the merchant, the user may receive a collectible digital character that is represented by a particular blockchain token and/or type of blockchain token. The blockchain token may be utilized by a gaming platform to verify the user has rights to access a feature provided in the game such as the digital representation of the digital character.

At 732, the blockchain computer 118 may transmit an indication to the resource provider computer 108 that the requested blockchain token was generated and associated with the user's blockchain address.

At 734, the resource provider computer 108 may transmit any suitable data to the user device 104 to indicate the generation of the blockchain token. As a non-limiting example, the user device 104, upon receipt of the data at 626, may be configured to present a message “Congratulations! Your recent purchase at merchant X has qualified you to access character Y of the game Z!! Log in to game Z to access your new character!”

The method 700 may continue to steps 736-740. Steps 736-740 correspond to the steps 522-526 and 628-632 described above in connection with FIGS. 5 and 6, respectively. At the end of the day or at some other suitable time interval, a clearing and settlement process between the resource provider computer 108, the transport computer 110, the processing network computer 112, and/or the authorizing entity computer 114 may be performed on the transaction.

### Technical Improvements

By utilizing the techniques described herein, a blockchain address may be associated with a payment credential such that blockchain tokens associated with a user's blockchain address may be utilized to determine a set of operations to be performed in response to performing a transaction with the user's associated payment credential (e.g., as part of a transaction between a user and a merchant). Accordingly, blockchain tokens (e.g., representing ownership, financial instruments, offer eligibility, and/or membership) along with transaction data may be utilized to determine a user has met a conditions of an offer and to perform one or more operations accordingly. Similarly, transaction data (e.g., current transaction data, historical transaction data, etc.) may be utilized to generate one or more blockchain tokens that may influence subsequent operations performed in response to subsequent transactions. The techniques discussed herein enable flexible transaction programmability with a stable means of exchange which will provide the building blocks for future innovative applications and business models in our increasingly programmed world.

Any of the computing devices described herein may be an example of a computer system that may be used to implement any of the entities or components described above. The subsystems of such a computer system may be are interconnected via a system bus. Additional subsystems include a printer, keyboard, storage device, and monitor, which is coupled to display adapter. Peripherals and input/output (I/O) devices, which couple to I/O controller, can be connected to the computer system by any number of means known in the art, such as a serial port. For example, I/O port or external interface can be used to connect the computer apparatus to a wide area network such as the Internet, a mouse input device, or a scanner. The interconnection via system bus may allow the central processor to communicate with each subsystem and to control the execution of instructions from system memory or the storage device, as well as the exchange of information between subsystems. The system memory and/or the storage device may embody a computer-readable medium.

As described, executing the techniques described above may involve implementing one or more functions, processes, operations or method steps. In some embodiments, the functions, processes, operations or method steps may be implemented as a result of the execution of a set of instructions or software code by a suitably-programmed computing device, microprocessor, data processor, or the like. The set of instructions or software code may be stored in a memory or other form of data storage element which is accessed by the computing device, microprocessor, etc. In other embodiments, the functions, processes, operations or method steps may be implemented by firmware or a dedicated processor, integrated circuit, etc.

Any of the software components or functions described in this application, may be implemented as software code to be executed by a processor using any suitable computer language such as, for example, Java, C++ or Perl using, for example, conventional or object-oriented techniques. The software code may be stored as a series of instructions, or commands on a computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus, and may be present on or within different computational apparatuses within a system or network.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention.

A recitation of “a”, “an” or “the” is intended to mean “one or more” unless specifically indicated to the contrary.

All patents, patent applications, publications, and descriptions mentioned above are herein incorporated by reference in their entirety for all purposes. None is admitted to be prior art.

What is claimed is:

1. A computer-implemented method, comprising:
obtaining, by a server computer, a mapping between a blockchain address and a payment credential associated with a user, the mapping having been generated based at least in part on blockchain data associated with the blockchain address and a set of conditions;
receiving, by the server computer, an authorization request message comprising message data that includes at least the payment credential;
obtaining, by the server computer, the set of conditions based at least in part on the payment credential;
determining that the set of conditions has been met based on at least a portion of the message data; and
executing one or more operations based on determining that the set of conditions have been met.

2. The computer-implemented method of claim 1, wherein the blockchain data associated with the blockchain address comprises one or more blockchain tokens that indicate ownership, membership, or eligibility associated with the user.

3. The computer-implemented method of claim 1, wherein the mapping is obtained from a condition management computer configured to perform an enrollment process with a user device.

4. The computer-implemented method of claim 1, wherein the set of conditions are obtained from a condition management computer that is configured to receive the set of conditions as part of an enrollment process performed with a resource provider computer.

5. The computer-implemented method of claim 1, further comprising:
performing, by the processing network computer, a first enrollment process with a resource provider computer, wherein the set of conditions are obtained from the resource provider computer during performance of the first enrollment process.

6. The computer-implemented method of claim 5, further comprising:
performing, by the processing network computer, a second enrollment process with a user device, wherein the account identifier and the blockchain address are obtained from the user device during performance of the second enrollment process.
obtaining the blockchain data associated with the blockchain address;
determining that at least one condition of the set of conditions has been met based at least in part on the blockchain data, wherein the mapping is generated based at least in part on determining the at least one condition has been met.

7. The computer-implemented method of claim 1, wherein executing the one or more operations comprises modifying an amount associated with the user account.

8. The computer-implemented method of claim 1, wherein executing the one or more operations comprises transmitting, to a resource provider computer associated with the set of conditions, an indication that the set of conditions have been met, wherein the resource provider computer is configured to cause one or more digital assets to be associated with the blockchain address based on receiving the indication that the set of conditions have been met.

9. The computer-implemented method of claim 1, wherein determining that the set of conditions have been met comprises identifying one or more blockchain tokens associated with the blockchain address.

10. The computer-implemented method of claim 1, wherein determining that the set of conditions have been met is further based on obtaining third party data initially provided by one or more third-party provider computers.

11. A server computer, comprising:
one or more processors; and
one or more memories comprising computer-executable instructions that, when executed by the one or more processors, cause the server computer to:
obtain a mapping between a blockchain address and a payment credential associated with a user, the mapping having been generated based at least in part on blockchain data associated with the blockchain address and a set of conditions;
receive an authorization request message comprising message data that includes at least the payment credential;
obtain the set of conditions based at least in part on the payment credential;
determine that the set of conditions has been met based on at least a portion of the message data; and
execute one or more operations based on determining that the set of conditions have been met.

12. The server computer of claim 11, wherein the blockchain data associated with the blockchain address comprises one or more blockchain tokens that indicate ownership, membership, or eligibility associated with the user.

13. The server computer of claim 11, wherein the mapping is obtained from a condition management computer configured to perform an enrollment process with a user device.

14. The server computer of claim 11, wherein the set of conditions are obtained from a condition management computer that is configured to receive the set of conditions as part of an enrollment process performed with a resource provider computer.

15. The server computer of claim 11, wherein executing the computer-executable instructions by the one or more processors further cause the server computer to:
perform a first enrollment process with a resource provider computer, wherein the set of conditions are obtained from the resource provider computer during performance of the first enrollment process.

16. The server computer of claim 15, wherein executing the computer-executable instructions by the one or more processors further cause the server computer to:
perform a second enrollment process with a user device, wherein the account identifier and the blockchain address are obtained from the user device during performance of the second enrollment process.
obtain the blockchain data associated with the blockchain address;
determine that at least one condition of the set of conditions has been met based at least in part on the blockchain data, wherein the mapping is generated based at least in part on determining the at least one condition has been met.

17. The server computer of claim 1, wherein executing the one or more operations comprises modifying an amount associated with the user account.

18. The server computer of claim 1, wherein executing the one or more operations comprises transmitting, to a resource provider computer associated with the set of conditions, an indication that the set of conditions have been met, wherein the resource provider computer is configured to cause one or more digital assets to be associated with the blockchain address based on receiving the indication that the set of conditions have been met.

19. The server computer of claim 1, wherein determining that the set of conditions have been met comprises identifying one or more blockchain tokens associated with the blockchain address.

20. The server computer of claim 1, wherein determining that the set of conditions have been met is further based on obtaining third party data initially provided by one or more third-party provider computers.
